(19) United States
(12) Patent Application Publication
(10) Pub. No.: US 2011/0020029 A1
(43) Pub. Date: Jan. 27, 2011

(54) CHARGER, IMAGE FORMING APPARATUS AND METHOD FOR CLEANING CHARGER

(75) Inventor: Yoshihiro TAKAHASHI, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/839,292

(22) Filed: Jul. 19, 2010

Related U.S. Application Data
(60) Provisional application No. 61/228,818, filed on Jul. 27, 2009.

(51) Int. Cl. G03G 15/02

(52) U.S. Cl. 399/100

(57) ABSTRACT

In an embodiment, a charger including: an electrode to support a plurality of pins lined up at a certain pitch in a longitudinal direction; and a scraper with an edge face not vertical but tilted in the longitudinal direction of the electrode to scrape the pins.

### CROSS-REFERENCE TO RELATED APPLICATION

This application is based upon and claims the benefit of priority from U.S. provisional application 61/228,818, filed on Jul. 27, 2009, the entire contents of which is incorporated herein by reference.

### FIELD

Embodiments described herein relate generally to a stabilizer for an image forming apparatus.

### BACKGROUND

A film shaped elastic body to clean a saw-tooth electrode in a charger of an electrographic image forming apparatus has a plane in parallel with a thickness direction of the saw-tooth electrode. The plane contacts with the saw-tooth electrode.

### BRIEF DESCRIPTION OF THE DRAWINGS

FIG. 1 is a perspective view of an image forming apparatus including a charger seen from a forward left and an obliquely upward direction;

FIG. 2 is an appearance perspective view of the charger;

FIG. 3 is a cross sectional perspective view of the charger;

FIG. 4 is a sectional view of the charger at a line A-A shown in FIG. 2;

FIG. 5 is a partial perspective view of the frame;

FIG. 6 is a view of the floor seen from the head in the frame;

FIG. 7 is a view of the floor seen from the head in another embodiment of the frame;

FIG. 8 is a view of the floor seen from the head in another embodiment of the frame;

FIG. 9 is a view of the floor seen from the head in another embodiment of the frame;

FIG. 10 is a view of the floor seen from the head in another embodiment of the frame; and

FIG. 11 is a view of the floor seen from the head in another embodiment of the frame.

### DETAILED DESCRIPTION

In general, described herein relates to, in a charger, to deviate load given to pins from a scraper.

In one embodiment, a charger including an electrode to support a plurality of pins lined up at a certain pitch in a longitudinal direction and a scraper with an edge face not vertical but tilted in the longitudinal direction of the electrode to scrape the pins.

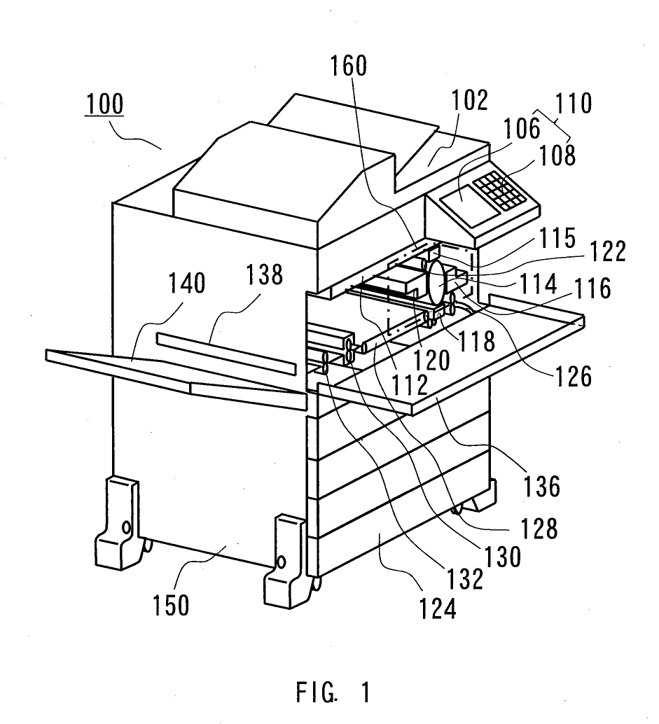

FIG. 1 is a perspective view of an image forming apparatus 100 including a charger seen from a forward left and an approximately obliquely upward direction. The image forming apparatus 100 includes an image reader 102 and an image forming portion 160. An operation panel 110 having a touch panel type display 106 and various operation keys 108 is at an upper portion of the image forming apparatus 100. A side to which the operation panel 110 is attached is a front side of the image forming apparatus 100. A side opposite to the side to which the operation panel 110 is attached is a rear side of the image forming apparatus 100. Hereinafter, with respect to each member, “front side” indicates the front side direction or portion of the image forming apparatus 100, and “rear side” indicates the rear side direction or portion of the image forming apparatus 100, in the same manner. The operation keys 108 of the operation panel 110 include specifically a numerical keypad, a reset key, a stop key, a start key and so on. Information required for image forming such as a sheet size, the number of copies, print density setting, binding processing is input at the operation panel 110.

The image forming portion 160 includes a laser unit 112, a photoconductor 114, a charger 115, a developer 116, a transferring device 118, a cleaner 120 and a neutralization device 122. The image forming apparatus 100 further includes a sheet feeder 124, a conveying path 126, a conveyor belt 128, a fixing device 130, a discharge roller 132 and a maintenance door 136. The charger 115 charges an outer circumference face of the rotating photoconductor 114. The laser unit 112 forms an electrostatic latent image on the charged outer circumference face of the photoconductor 114. The developer 116 makes toner adhere to the electrostatic latent image and develops into a toner image. The transferring device 118 transfers the toner image on a sheet conveyed from the sheet feeder 124 through the conveying path 126. The cleaner 120 removes toner remaining on the photoconductor 114 without being transferred. The neutralization device 122 neutralizes the outer circumference face of the photoconductor 114. The conveyor belt 128 conveys the sheet on which the toner image is transferred to the fixing device 130. The fixing device 130 fixes the toner image on the sheet. A sheet receiving port 138 is at a left side 150 of the image forming apparatus 100. The discharge roller 132 discharges the sheet on which the toner image is fixed from the sheet receiving port 138 to a sheet receiving tray 140. The image forming apparatus 100 includes the maintenance door 136 at the front side so as to open the fixing device 130 to the front side.

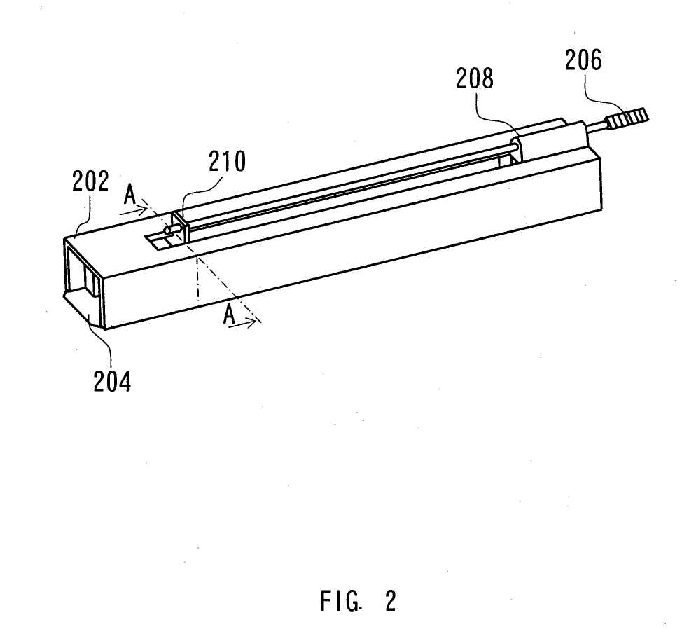

FIG. 2 is an appearance perspective view of the charger 115. The charger 115 includes a case 202, a grid 204, a handle 206, a rail 208 and a frame 210. The case 202 regulates so as not to radiate electromagnetic wave generated along with the charging. The case 202 supports the grid at a side near the photoconductor 114. The grid 204 is a stainless plate which is 0.1 mm thick, for example. A longitudinal direction of the case 202 is along an axial direction of the photoconductor 114. The case 202 includes a slit along the longitudinal direction. The frame 210 slides along the slit of the case 202. The rail 208 supports the handle 206 which slides in the longitudinal direction of the case 202. The handle 206 connects to the frame 210 so as to make the frame 210 slide.

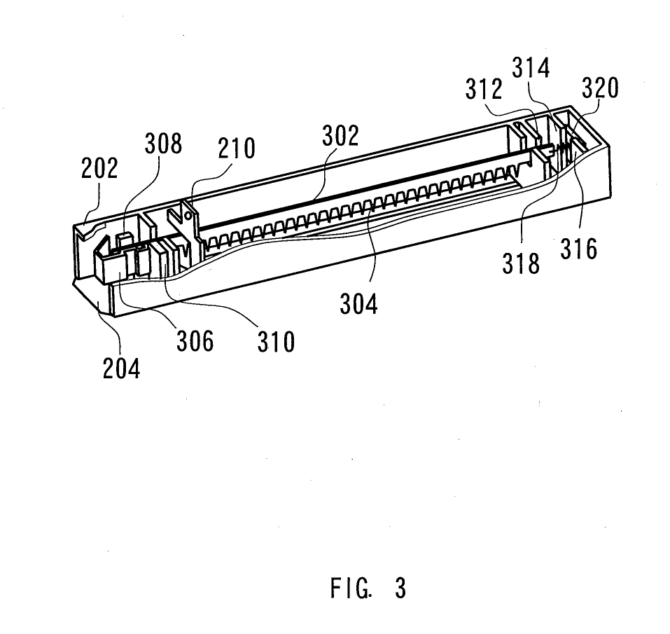

FIG. 3 is a cross sectional perspective view of the charger 115. The charger 115 further includes an electrode 302, a power feeding plate 306, a column 308, a column 310, a column 312, a column 314, a column 316, a spring 318 and an end plate 320.

The electrode 302 supports a plurality of pins 304 lined up at a certain pitch in the longitudinal direction of the case 202. The electrode 302 is a stainless plate which is 0.1 mm thick, for example. A plurality of pins 304 have a pitch of 2 mm, for example. The pins 304 face the grid 204. The pin 304 includes a length of 2 mm in a vertical direction for the grid 204. The pin 304 includes a curvature of 30 μm in radius, for example, at the tip. The tip of the pin 304 separates from the inner surface of the case 202 by not less than 7 mm, for example, so that current does not leak to the case 202.

The power feeding plate 306 conducts electricity to the electrode 302. The power feeding plate 306 is softer than the electrode 302 so as to make contact sufficiently with an electrical interface of the image forming apparatus 100. The power feeding plate 306 hooks the electrode 302 so that the electrode 302 does not slide against the power feeding plate 306 in the longitudinal direction of the case 202.

The column 308 contacts with one side face of the electrode 302. One side face of the power feeding plate 306 contacts with the other side face of the electrode 302. The column 310 arranged at a position displaced from the column 308 in the longitudinal direction of the case 202 contacts with the other side face of the power feeding plate 306 so as to sandwich the electrode 302 and the power feeding plate 306. The column 310 hooks the power feeding plate 306 so that the power feeding plate 306 does not slide in the longitudinal direction of the case 202. The column 312 contacts one side face of the electrode 302. A plurality of pins 304 are between the column 310 and the column 312.

One end of the spring 318 connects to the electrode 302. The other end of the spring 318 connects to the end plate 320. The column 314 and the column 316 regulate that the end plate 320 moves toward the column 310. The power feeding plate 306 and the end plate 320 hook the column 310, the column 314 and the column 316 so as to keep the tension of the electrode 302 via the spring 318.

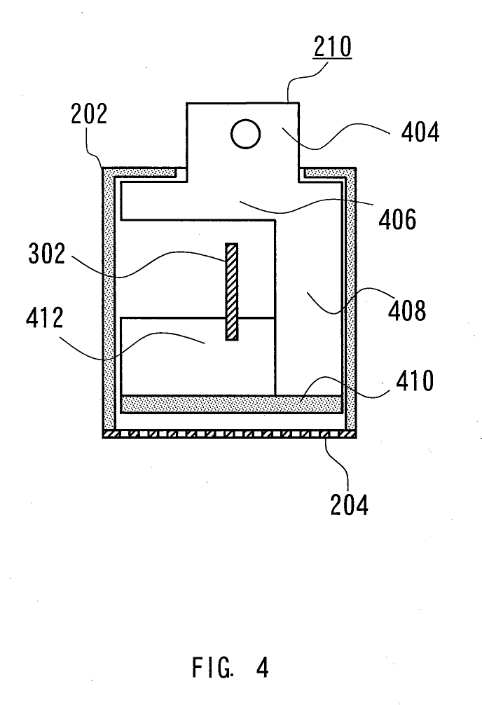

FIG. 4 is a sectional view of the charger 115 at a line A-A shown in FIG. 2. The frame 210 is insulating. The frame 210 is polypropylene, for example. A head 404, a bar 406, a post 408 and a floor 410 compose the frame 210. The head 404 throws out to the outside of the case 202 from the slit of the case 202 so as to connect to the handle 206. The bar 406 connects to the head 404 inside the case 202. The post 408 extends from the bar 406 in the vertical direction for the grid 204. The floor 410 extends from the post 408 in a direction parallel with the grid 204. The bar 406, the post 408 and the floor 410 enclose the electrode 302. The floor 410 faces the tips of the pins 304.

A scraper 412 extends from the floor 410 toward the electrode 302. The scraper 412 contacts with the tips of the pins 304. An edge side of the scraper 412 is nearer to the electrode 302 than the tips of the pins 304 by 0.1˜1.5 mm, for example, in the state that the scraper 412 stands so as not to contact with the pins 304. The scraper 412 is insulating. The scraper 412 is a polyester film or a polyimide sheet with a thickness of 10˜100 μm, for example. The scraper 412 is coated with abrading agent, for example. When the handle 206 makes the frame 210 slide, the scraper 412 which moves along with the frame 210 scrapes the pins 304 to clean. The case 202 covers the electrode 302 and the scraper 412.

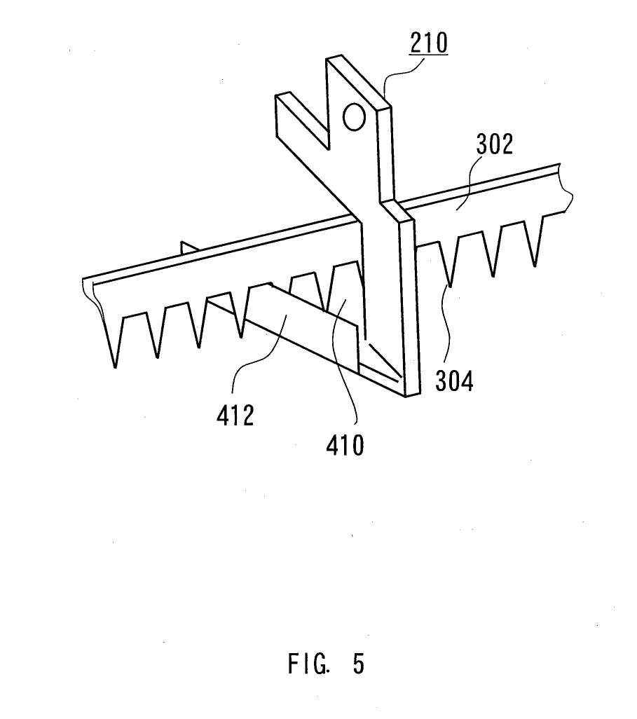

FIG. 5 is a partial perspective view of the frame 210. The edge side of the scraper 412 is not vertical for the longitudinal direction of the electrode 302. The edge side of the scraper 412 is tilted for the longitudinal direction of the electrode 302. The edge side of the scraper 412 is in parallel with the floor 410. A short direction of the scraper 412 is vertical for the floor 410, in the state that the scraper 412 stands so as not to contact with the pins 304.

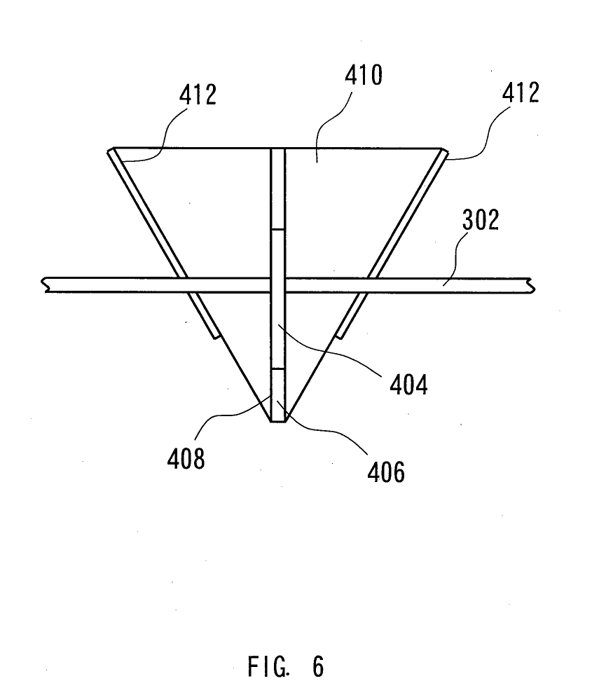

FIG. 6 is a view of the floor 410 seen from the head 404 in the frame 210. The floor 410 supports the two scrapers 412. The edge sides of the two scrapers 412 are mutually tilted in reverse directions for the longitudinal direction of the electrode 302. In order to support the edge sides of the two scrapers 412 in the state that the edge sides are mutually tilted in the reverse directions for the longitudinal direction of the electrode 302, the floor 410 includes sides which are tilted mutually in the reverse directions. The floor 410 is a triangle which includes the two sides and the post 408 as an apex. One ends of the scrapers 412 are at the side of the floor 410 opposite to the apex.

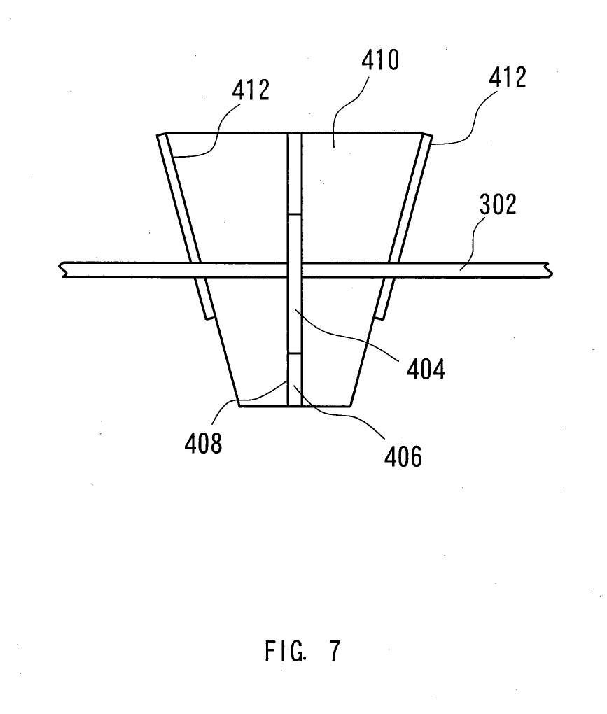

FIG. 7 is a view of the floor 410 seen from the head 404 in another embodiment of frame 210. The floor 410 is a trapezoid which includes the two sides supporting the two scrapers 412 and a side passing through the post 408.

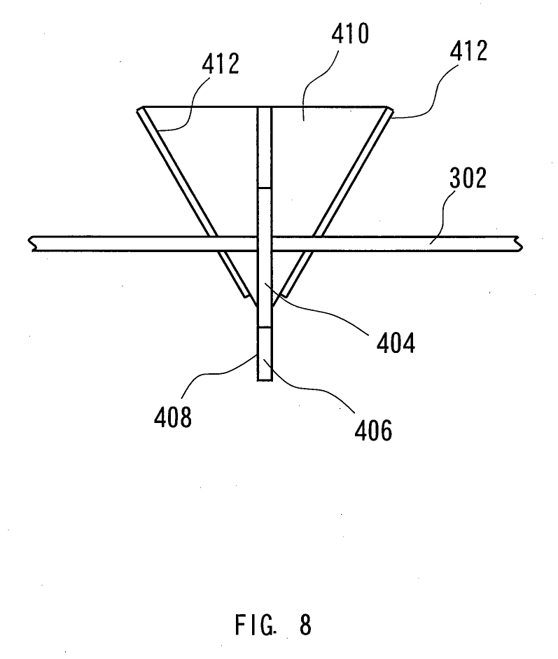

FIG. 8 is a view of the floor 410 seen from the head 404 in another embodiment of frame 210. The floor 410 is a triangle which includes the two sides supporting the two scrapers 412 and an apex at a position deviating from the post 408.

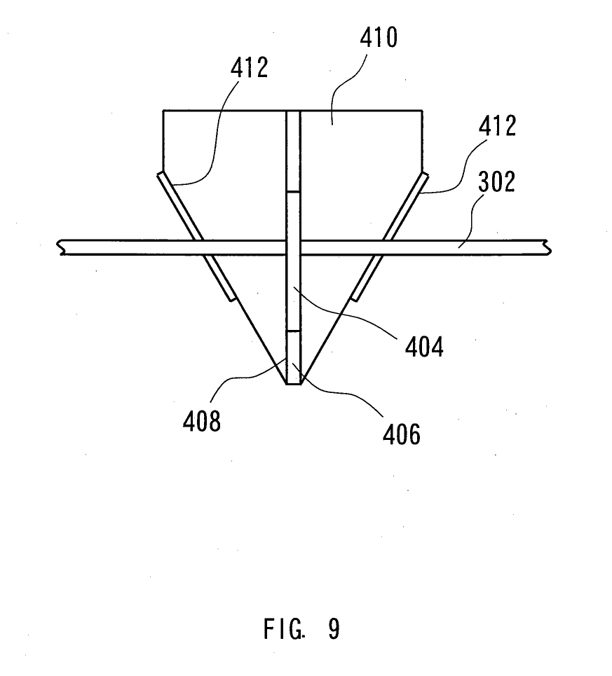

FIG. 9 is a view of the floor 410 seen from the head 404 in another embodiment of frame 210. One ends of the scrapers 412 do not reach a side of the floor 410 opposite to an apex which is an intersecting point of the two sides supporting the two scrapers 412.

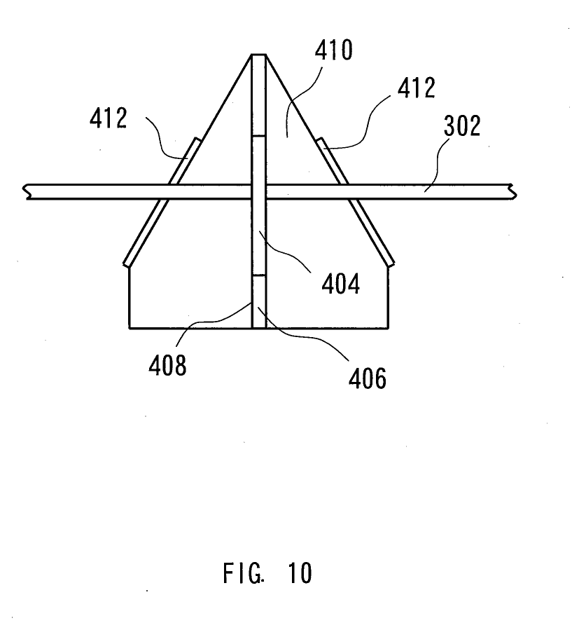

FIG. 10 is a view of the floor 410 seen from the head 404 in another embodiment of frame 210. The floor 410 is a triangle which includes the two sides supporting the two scrapers 412 and a side passing through the post 408 as a base.

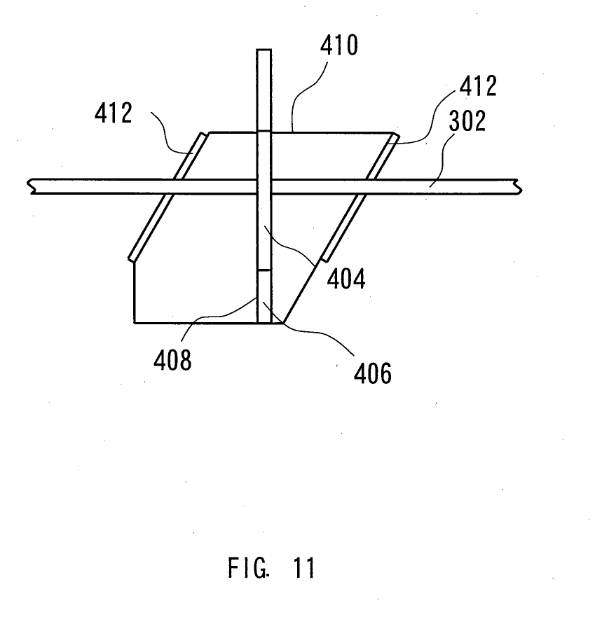

FIG. 11 is a view of the floor 410 seen from the head 404 in another embodiment of frame 210. The edge sides of the two scrapers 412 are respectively tilted in the same direction for the longitudinal direction of the electrode 302. In order to support such that the longitudinal directions of the two scrapers 412 are respectively tilted in the same direction for the longitudinal direction of the electrode 302, the floor 410 includes sides tilted in the same direction, respectively.

In any of the embodiments of the frame 210, in order to deviate load given to the pins 304 from the scraper 412, the edge side of the scraper 412 is not vertical but is tilted in the longitudinal direction of the electrode 302.

While certain embodiments have been described, those embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A charger, comprising:
an electrode to support a plurality of pins lined up at a certain pitch in a longitudinal direction; and
a scraper with an edge face not vertical but tilted in the longitudinal direction of the electrode to scrape the pins.

2. The device of claim 1, wherein edge sides of the two scrapers tilt mutually in reverse directions for the longitudinal direction.

3. The device of claim 1, wherein the edge side of the scraper in the state of standing so as not to contact with the pins is nearer to the electrode than the tips of the pins.

4. The device of claim 1, wherein a short direction of the scraper in the state of standing so as not to contact with the pins is vertical for the longitudinal direction.

5. The device of claim 1, further comprising a frame to support the scraper.

6. The device of claim 5, further comprising a handle to make the frame move in the longitudinal direction.

7. The device of claim 6, wherein the frame supports the two scrapers.

8. The device of claim 7, further comprising:
a case to cover the electrode and the scrapers; and
a grid facing the pins.

9. The device of claim 8, wherein the frame comprising:
a head throwing out to outside of the case;
a bar connecting to the head inside of the case;
a post extending from the bar in a vertical direction for the grid; and
a floor extending in a direction in parallel with the grid to face tips of the pins.

10. The device of claim 8, wherein an edge side of the scraper is in parallel with the floor.

11. The device of claim 10, wherein a short direction of the scraper in the state of standing so as not to contact with the pins is vertical to the floor.

12. The device of claim 10, wherein the floor comprises two sides which are tilted mutually in reverse directions so as to support the edge sides of the two scrapers in the state that the edge sides are mutually tilted in the reverse directions for the longitudinal direction.

13. The device of claim 12, wherein the floor is a triangle which comprises the two sides and the post as an apex.

14. The device of claim 13, wherein the one ends of the scrapers are at a side of the floor opposite to the apex.

15. The device of claim 12, wherein the floor is a trapezoid which comprises the two sides supporting the two scrapers and a side passing through the post.

16. The device of claim 12, wherein the floor is a triangle which comprises the two sides supporting the two scrapers and an apex at a position deviating from the post.

17. The device of claim 12, wherein one ends of the scrapers do not reach a side of the floor opposite to an apex which is an intersecting point of the two sides supporting the two scrapers.

18. The device of claim 12, wherein the floor is a triangle which comprises the two sides supporting the two scrapers and a side passing through the post as a base.

19. An image forming apparatus, comprising:
a photoconductor to support an electrostatic latent image;
a charger including an electrode to support a plurality of pins lined up at a certain pitch in a longitudinal direction, and a scraper with an edge face not vertical but tilted in the longitudinal direction of the electrode to scrape the pins, to charge the photoconductor;
a laser unit to form the electrostatic latent image on the charged photoconductor; and
a developer to develop the electrostatic latent image to a toner image.

20. A method for cleaning a charger, comprising:
charging a photoconductor by a charger including an electrode to support a plurality of pins lined up at a certain pitch in a longitudinal direction, and a scraper with an edge face not vertical but tilted in the longitudinal direction of the electrode to scrape the pins; and
scraping the pins by the scraper.
